(19) United States
(12) Patent Application Publication
(10) Pub. No.: US 2026/0264592 A1
(43) Pub. Date: Sep. 10, 2026

(54) ARMREST AND CONSOLE ASSEMBLY WITH THE SAME

(71) Applicant: KOMOS CO., LTD., Hwaseong-si Gyeonggi-do (KR)

(72) Inventors: Hyeon Muk KIM, Seoul (KR); Dong Min KIM, Anyang-si Gyeonggi-do (KR); In Chul YOO, Hwaseong-si Gyeonggi-do (KR)

(73) Assignee: KOMOS CO., LTD., Hwaseong-si Gyeonggi-do (KR)

(21) Appl. No.: 19/536,843

(22) Filed: Feb. 11, 2026

(30) Foreign Application Priority Data
Mar. 6, 2025 (KR) 10-2025-0029151

(51) Int. Cl. B60N 2/75

(52) U.S. Cl. CPC B60N 2/77; B60N 2/767

(57) ABSTRACT

Provided are an armrest and a console assembly. The armrest includes a base frame, an armrest body that is movable up and down with respect to the base frame, an armrest cover mounted on an upper portion of the armrest body, and a link unit allowing the armrest body to move up and down with respect to the base frame, and the height of the armrest body is adjusted to a first position at which the armrest body is seated on the base frame and a second position at which the armrest body moves upward to the highest position, according to an operation of the link unit.

### CROSS-REFERENCE TO RELATED APPLICATION

This application claims priority to Korean Patent Application No. 10-2025-0029151 filed on Mar. 6, 2025, the entire content of which is incorporated by reference.

### BACKGROUND

### 1. Field

The disclosure relates to an armrest and a console assembly including the armrest. More particularly, the disclosure relates to an armrest that is movable in an up-and-down direction and a forward-and-backward direction and a console assembly including the armrest, for the convenience of the driver and passengers.

### 2. Description of the Related Art

Console assemblies of moving items such as vehicles are installed between driver's seats and front passenger seats of vehicles and include storage bins storing items, and armrests that serve as covers and allow passengers to comfortably rest their arms are provided on the storage bins.

Recently, additional facilities for use convenience of passengers have been required. Accordingly, there is a demand for armrests that move forward and backward or upward and downward to fit users' bodies rather than fixed.

The information disclosed in the background section of the disclosure is intended merely to aid in understanding the overall background of the disclosure and should not be construed as acknowledging or implying in any form that such information constitutes the related art known to one of ordinary skill in the art.

### SUMMARY

Provided are an armrest which may significantly improve user convenience through a height adjustment function of the armrest compared to the existing stationary armrest and a console assembly including the armrest.

Provided are also an armrest that is applicable to various physical conditions of a user through a movement function of an armrest cover and a console assembly including the armrest.

The solutions of the disclosure are not limited to the above-mentioned contents, and other technical problems not mentioned will be clearly understood by one of ordinary skill in the art from the following description.

According to an embodiment of the disclosure, an armrest includes a base frame, an armrest body that is movable up and down with respect to the base frame, an armrest cover mounted on an upper portion of the armrest body, and a link unit allowing the armrest body to move up and down with respect to the base frame, and the height of the armrest body is adjusted to a first position at which the armrest body is seated on the base frame and a second position at which the armrest body moves upward to the highest, according to an operation of the link unit.

The link unit may include a first link and a second link connecting the base frame to the armrest body and intersecting each other, and the height of the armrest body may be adjusted as an intersection angle of the first link and the second link changes.

The link unit may include a torsion spring provided on one of the first link and the second link to bias the armrest body upward.

Ends of the first link and the second link may be rotatably connected to the base frame and the armrest body, respectively, and other ends of the first link and the second link may be guided and connected to a link connection groove of the base frame and a link connection groove of the armrest body to be rotatable and horizontally movable.

The armrest may further include a locking unit locking an operation of the link unit such that the armrest body is fixed at the first position and the second position.

The locking unit may include a rotatable stopper restricting a movement of the other end of the second link moving within the link connection groove of the base frame, and a switch unit rotating the stopper.

Two groove portions in which a rotation axis of the other end of the second link is seated may be provided in the stopper.

The switch unit may include a switch provided to be exposed to the base frame, and a stopper link connecting one end of the switch to one end of the stopper so as to rotate the stopper according to the up-and-down movement of the switch.

One end of the stopper link may be connected to the switch, and a cam rotating according to a movement of the stopper link and engaged with a gear of the stopper may be provided in the other end of the stopper link.

The armrest cover may move in a longitudinal direction from the armrest body.

A protrusion portion may be provided on an inner circumferential surface of the armrest cover such that the armrest cover is fixed at a predetermined position of the armrest body, and a fixing groove portion into which the protrusion portion is inserted may be provided in an outer circumferential surface of the armrest body.

According to another embodiment of the disclosure, a console assembly provided on a moving object includes a console body provided on the moving object and storing items, and an armrest with one end rotatably provided on an upper portion of the console body, and the armrest includes a base frame, an armrest body that is movable up and down with respect to the base frame, an armrest cover mounted on an upper portion of the armrest body, and a link unit allowing the armrest body to move up and down with respect to the base frame, and the height of the armrest body is adjusted to a first position at which the armrest body is seated on the base frame and a second position at which the armrest body moves upward to the highest, according to an operation of the link unit.

### BRIEF DESCRIPTION OF THE DRAWINGS

FIG. 1 is a diagram illustrating a first state of a console assembly according to an embodiment of the disclosure;

FIG. 2 is a diagram illustrating a second state of a console assembly according to an embodiment of the disclosure;

FIG. 3 is a diagram illustrating the height of an armrest being adjusted to a second position according to an embodiment of the disclosure;

FIG. 4 is an exploded perspective view of an armrest according to an embodiment of the disclosure;

FIG. 5 is an exploded perspective view of a link unit according to an embodiment of the disclosure;

FIG. 6 is a cross-sectional view of a link unit according to an embodiment of the disclosure;

FIG. 7 is a cross-sectional perspective view of an armrest as viewed from a side thereof according to an embodiment of the disclosure;

FIG. 8 is a diagram illustrating a locking unit;

FIG. 9 is a diagram illustrating an operation of an armrest according to unlocking of a locking unit;

FIG. 10 is a front cross-sectional view of an armrest according to an embodiment of the disclosure;

FIG. 11 is a top cross-sectional view of an armrest as viewed from an upper surface thereof according to an embodiment of the disclosure;

FIG. 12 is a diagram illustrating an armrest moving forward from a first position according to an embodiment of the disclosure; and

FIG. 13 is a diagram illustrating an armrest moving forward from a second position according to an embodiment of the disclosure.

### DETAILED DESCRIPTION

Hereinafter, embodiments of the disclosure will be described in detail with reference to the accompanying drawings so that one of ordinary skill in the art may easily implement the disclosure. The disclosure may, however, be embodied in many different forms and should not be construed as being limited to the embodiments set forth herein. For clarity, portions that are not relevant to the description of the disclosure are omitted.

The terms used in the specification are merely used to describe particular embodiments of the disclosure, and are not intended to limit the disclosure. An expression used in the singular encompasses the expression of the plural, unless it has a clearly different meaning in the context.

In the specification, it is to be understood that the terms such as "including", "having," and "comprising" are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the disclosure are shown independently to represent different characteristic functions, and do not mean that each component includes separate hardware or one software unit. That is, each component is described by listing each component for convenience of description, and at least two of the components may be combined to form one component, or one component may be divided into a plurality of components to perform a function. The integrated and separated embodiments of each of these components are also included within the scope of the disclosure without departing from the spirit of the disclosure.

In addition, embodiments below are provided so that the disclosure will be thorough and complete, and will fully convey the concept of the disclosure to one of ordinary skill in the art. In the drawings, sizes and thicknesses of components may be exaggerated for clarity.

Hereinafter, the disclosure will be described in detail with reference to the attached drawings.

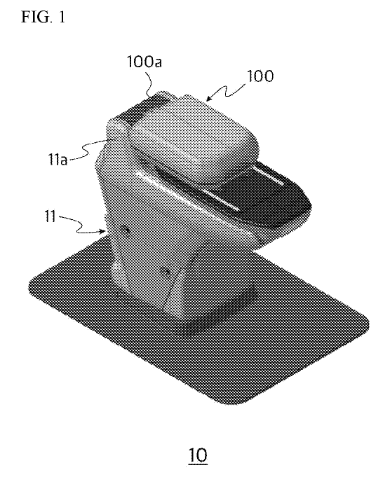

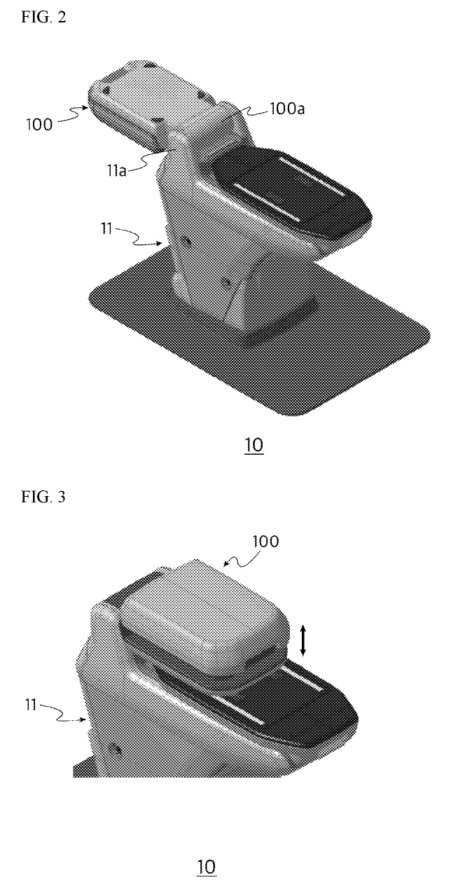

FIG. 1 is a diagram illustrating a first state of a console assembly 10 according to an embodiment of the disclosure. FIG. 2 is a diagram illustrating a second state of the console assembly 10 according to an embodiment of the disclosure.

Referring to FIGS. 1 and 2, the console assembly 10 according to an embodiment of the disclosure is installed on a moving object such as a car or an airplane and provided for use convenience by passengers, and may include a console body 11 and an armrest 100. The armrest 100 of the console assembly 10 according to an embodiment of the disclosure may be usable as an armrest or a table according to a rotational state, and one end 100a thereof may be rotatably provided on an upper portion 11a of the console body 11.

In an embodiment, the armrest 100 may be rotated 180 degrees from the first state shown in FIG. 1 to be changed to the second state shown in FIG. 2. The armrest 100 may be used as an armrest in the first state, and may be used as a table in the second state. The armrest 100 may be rotated back to the first state from the second state.

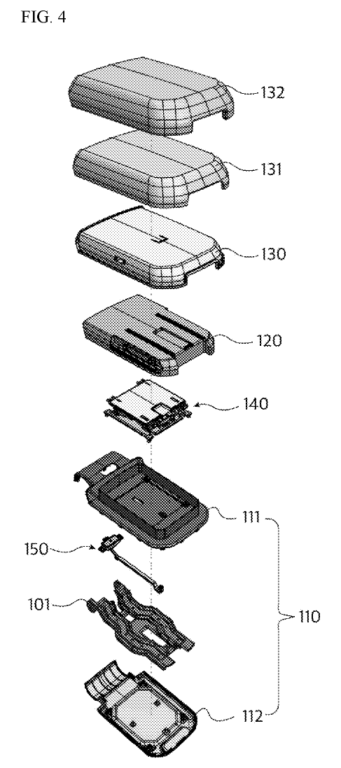

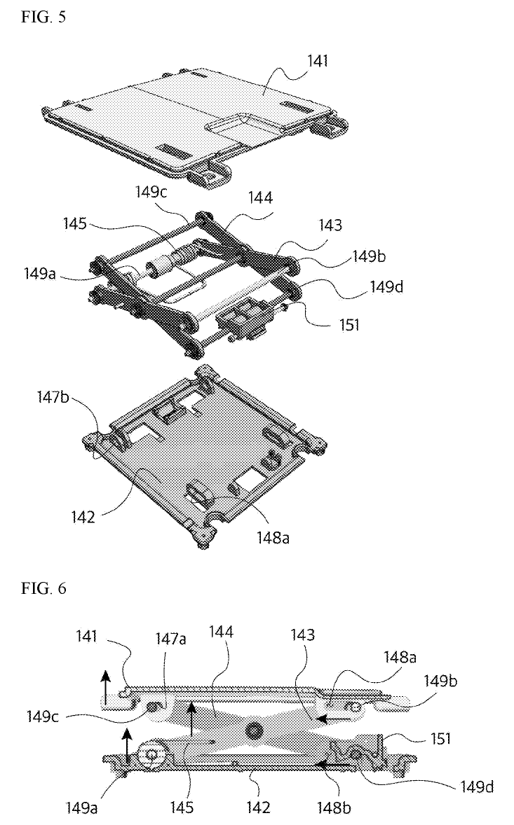

FIG. 3 is a diagram illustrating the height of the armrest 100 being adjusted to a second position according to an embodiment of the disclosure. FIG. 4 is an exploded perspective view of the armrest 100 according to an embodiment of the disclosure. FIG. 5 is an exploded perspective view of a link unit 140 according to an embodiment of the disclosure. FIG. 6 is a cross-sectional view of the link unit 140 according to an embodiment of the disclosure.

Referring to FIGS. 3 and 6, the armrest 100 according to an embodiment of the disclosure may include a base frame 110, an armrest body 120 that is movable up and down with respect to the base frame 110, an armrest cover 130 mounted on an upper portion of the armrest body 120, and the link unit 140 allowing the armrest body 120 to move up and down with respect to the base frame 110. The height of the armrest body 120 may be adjusted to a first position at which the armrest body 120 is seated on the base frame 110 as shown in FIG. 1 and the second position at which the armrest body 120 moves upward to the highest position as shown in FIG. 3, according to the operation of the link unit 140.

The base frame 110 is coupled to the console assembly 10 to support the armrest 100, and may be formed integrally or may be configured as a base frame upper cover 111 and a base frame lower cover 112 according to an embodiment. A hinge bracket 101 may be coupled to an inner space of the base frame 110 to be rotatably connected to the console body 11.

The armrest body 120 may be provided in an upper portion of the base frame 110. The armrest body 120 is a support formed to move up and down with respect to the base frame 110, and may support the armrest cover 130 on an upper portion thereof. The armrest body 120 may be adjusted to a height desired by a user while moving up and down according to the operation of the link unit 140.

The armrest cover 130 may be mounted on an upper portion of the armrest body 120 to form a surface on which the user actually rests the user's arm. According to an embodiment, the armrest cover 130 may further include an armrest foam 131 and an armrest skin 132. The armrest foam 131 is for buffering a part where the user's arm touches, and may include a material such as foam or sponge. The armrest skin 132 is a final finishing material exposed to the outside, and may include various materials such as artificial leather, cloth, and synthetic resin.

The link unit 140 may be provided in a space formed by the base frame 110 and the armrest body 120. The link unit 140 is for moving the armrest body 120 up and down with respect to the base frame 110, and may include a first link 143 and a second link 144 that connect the base frame 110 to the armrest body 120 and intersect each other. The height of the armrest body 120 may be adjusted as the intersection angle of the first link 143 and the second link 144 changes.

Ends of the first link 143 and the second link 144 may be rotatably connected to the base frame 110 and the armrest body 120, respectively, and the other ends of the first link 143 and the second link 144 may be guided to a link connection groove 148b formed in the base frame 110 and a link connection groove 148a formed in the armrest body 120 to be rotatable and horizontally movable.

Specifically, in an embodiment, the link unit 140 may include a first bracket 141, a second bracket 142, the first link 143, and the second link 144.

The first bracket 141 may be coupled to a lower portion of the armrest body 120 to support the armrest body 120 and move integrally with the armrest body 120. The second bracket 142 may be fixedly provided on the base frame 110 to serve as a fixing point for the operation of the link unit 140. Because the first bracket 141 moves integrally with the armrest body 120, and the second bracket 142 moves integrally with the base frame 110, an armrest body recited in the claims may be understood as the first bracket 141, and a base frame as the second bracket 142. In the description below, the first bracket 141 and the second bracket 142 may be omitted according to an embodiment and respectively replaced with the armrest body 120 and the base frame 110 so that the armrest body 120 and the base frame 110 may directly serve as the first bracket 141 and the second bracket 142.

Ends of the first link 143 and the second link 144 may be rotatably connected to the first bracket 141 and the other ends thereof may be rotatably connected to the second bracket 142 so that the first link 143 and the second link 144 may be provided to intersect each other in an 'X' shape. The first link 143 and the second link 144 intersecting each other in the 'X' shape may be provided in a pair as shown in FIG. 5, but are not limited thereto, and may be provided alone rather than in a pair according to an embodiment.

Rotation axes 149a, 149b, 149c, and 149d may be provided at the ends of the first link 143 and the second link 144. The rotation axes 149a, 149b, 149c, and 149d may be respectively inserted into first link connection grooves 147a and 147b and second link connection grooves 148a and 148b formed in the first bracket 141 and the second bracket 142 to connect the first link 143 and the second link 144 to the first bracket 141 and the second bracket 142. The first link connection grooves 147a and 147b may be rotatably coupled to the rotation axes 149a and 149c. The second link connection grooves 148a and 148b may have a groove shape extending in a horizontal direction so as to be movable a predetermined distance in the horizontal direction, and the inserted rotation axes 149b and 149d may rotate while slidably moving the predetermined distance.

The link unit 140 may further include a torsion spring 145 provided on one of the first link 143 and the second link 144 to bias the armrest body 120 upward.

Specifically, the torsion spring 145 is for providing a biasing force to press one of the first link 143 and the second link 144 in a direction of the first bracket 141. In an embodiment, as shown

in FIGS. 5 and 6, when the torsion spring 145 is connected to the first link 143, the torsion spring 145 may press the first link 143 in the direction of the first bracket 141. In this regard, one end of the first link 143 may rotate around the rotation axis 149a, and the other end thereof may rotate through the rotation axis 149b inserted into the second link connection groove 148a of the first bracket 141 while moving a predetermined distance in the horizontal direction. The second link 144 intersecting with the first link 143 may also operate in the same manner.

That is, the elastic force provided by the torsion spring 145 may press the first link 143 upward, and the second link 144 may form the 'X' shape and operate together with the first link 143 so that the first link 143 and the second link 144 may be unfolded. Accordingly, the first bracket 141 may move up and down, and the armrest body 120 supported by the first bracket 141 may move up and down from the first position shown in FIG. 1 to the second position shown in FIG. 3.

In addition, the torsion spring 145 may allow the armrest body 120 to operate smoothly when the armrest body 120 moves upward, and prevent the armrest body 120 from falling sharply when the armrest body 120 moves down.

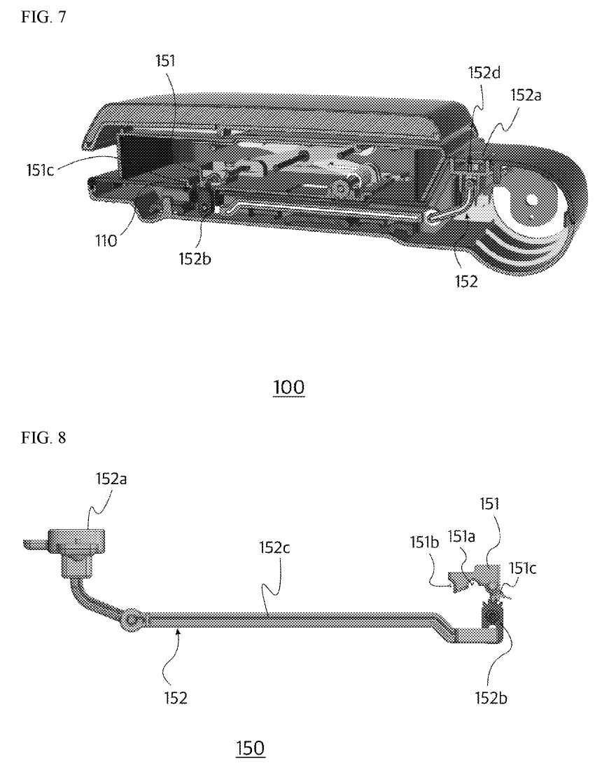

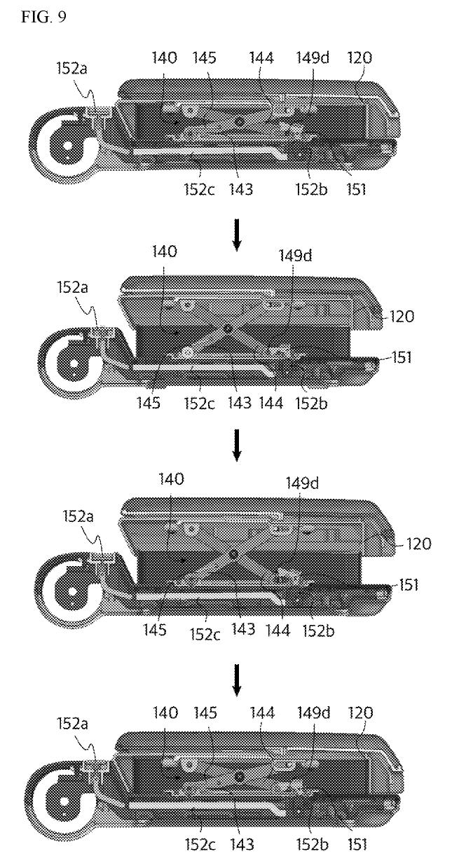

FIG. 7 is a cross-sectional perspective view of the armrest 100 as viewed from a side thereof according to an embodiment of the disclosure. FIG. 8 is a diagram illustrating a locking unit 150. FIG. 9 is a diagram illustrating an operation of the armrest 100 according to unlocking of the locking unit 150.

Referring to FIGS. 4 to 9, in an embodiment, the armrest 100 may further include the locking unit 150. The locking unit 150 is for locking or unlocking the operation of the link unit 140 so that the position of the armrest body 120 is fixed at the first position or the second position, and may include a stopper 151 and a switch unit 152.

The stopper 151 is for restricting the movement of the other end of the second link 144 moving within a link connection groove 148 of the base frame 110, and may be rotatably provided.

In an embodiment, two groove portions 151a and 151b in which the rotation axis 149b of the other end of the second link 144 are seated at a specific position may be formed in the stopper 151. The first groove portion 151a is for fixing the first position of the armrest body 120, and the rotation axis 149b of the other end of the second link 144 may be seated therein to limit the horizontal movement of the rotation axis 149b. The second groove portion 151b is for fixing the second position of the armrest body 120, and the rotation axis 149b of the other end of the second

link 144 may be seated therein to limit the horizontal movement of the rotation axis 149b. The first and second grooves 151a and 151b may restrict the operation of the link unit 140 by limiting the movement of the rotation axis 149b of the second link 144.

The switch unit 152 is for rotating the stopper 151, and may include a switch 152a, a cam 152b, and a stopper link 152c.

The switch 152a may be exposed on an outer surface of the base frame 110 so as to enable a user operation. The switch 152a may transfer an operational force to the cam 152b through the stopper link 152c so that the stopper 151 may lock or unlock the operation of the link unit 140. In an embodiment, a return spring 152d may be provided in the switch 152a to return the switch 152a to its original position after the operation of the switch 152a.

The cam 152b is configured to rotate according to the operation of the switch 152a, and may be disposed to be engaged with a stopper gear 151c extending from the stopper 151. When the cam 152b is engaged with the stopper gear 151c, the cam 152b may rotate by a predetermined angle upon each operation of the switch 152a, and the stopper 151 may rotate in conjunction with the cam 152b. When the stopper 151 rotates, the rotation axis 149b may be separated from the first and second grooves 151a and 151b of the stopper 151 so that the link unit 140 may be unlocked.

The stopper link 152c is for transferring the operational force from the switch 152a to the cam 152b. According to the operation of the switch 152a, the stopper link 152c may linearly move or rotate to apply force to the cam 152b, and thus, the cam 152b rotates the stopper 151. The stopper link 152c may be in the form of a long rod or a combination of a plurality of links.

Referring to FIG. 9, with regard to operations of the armrest 100 moving up and down according to the operation of the locking unit 150, when the user presses the switch 152a, the stopper link 152c may move or rotate so that the cam 152b may rotate. When the cam 152b rotates, the stopper 151 engaged with the cam 152b and the stopper gear 151c may rotate. When the stopper 151 rotates, the rotation axis 149d of the other end of the second link 144 restricted in the first groove 151a may be separated therefrom. In this regard, the first link 143 may operate by the elastic force of the torsion spring 145, and accordingly, the second link 144 may also operate, the link unit 140 may be unfolded, and the armrest body 120 may move up and down. As the rotation axis 149d of the other end of the second link 144 moves horizontally, the armrest body 120 may move upward to the second position, when the switch 152a and the stopper 151 return to their original positions, the rotation axis 149d of the other end of the second link 144 may be restricted in the second groove 151b of the stopper 151 such that the height of the armrest body 120 may be fixed at the second position.

While the link unit 140 is unlocked by the user pressing the switch 152a, when the user presses the upper surface of the armrest body 120, the link unit 140 may be folded again, and the armrest body 120 may return to the first position. In this state, when the switch 152a returns to its original position, the rotation axis 149d of the other end of the second link 144 may be seated again in the first groove 151a of the stopper 151 and its movement is limited so that the operation of the link unit 140 may be locked and the armrest 100 may be fixed to the first position.

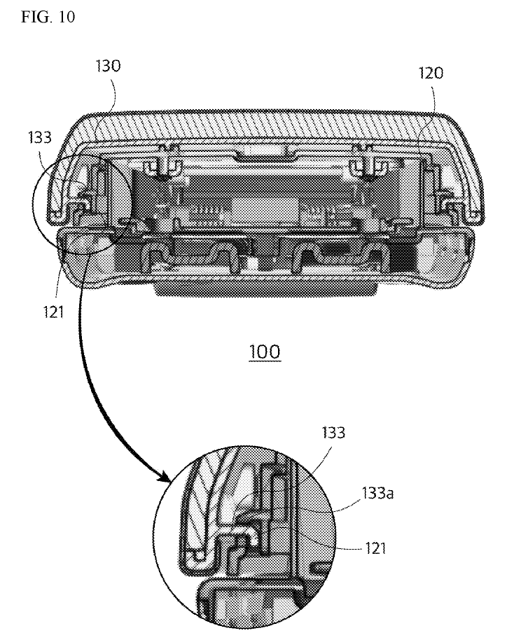

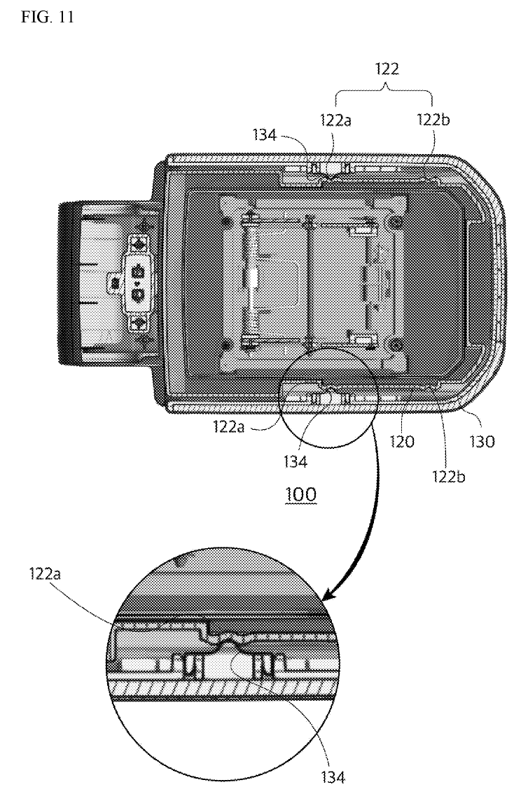

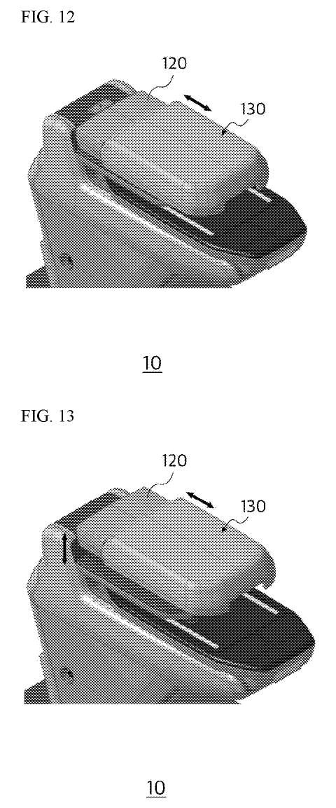

FIG. 10 is a front cross-sectional view of the armrest 100 according to an embodiment of the disclosure. FIG. 11 is a top cross-sectional view of the armrest 100 as viewed from an upper surface thereof according to an embodiment of the disclosure. FIG. 12 is a diagram illustrating the armrest 100 moving forward from a first position according to an embodiment of the disclosure. FIG. 13 is a diagram illustrating the armrest 100 moving forward from a second position according to an embodiment of the disclosure.

Referring to FIGS. 10 and 13, in the armrest 100 according to an embodiment of the disclosure, the armrest cover 130 may move in a longitudinal direction from the armrest body 120 at the first position or the second position. To this end, a guide groove portion 121 for guiding a sliding movement path may be formed in the armrest body 120, and a guide portion 133 correspondingly inserted into and engaged with the guide groove portion 121 may be protruded from and formed in the armrest cover 130. The guide portion 133 may include a bending portion 133a so as not to be separated from the guide groove portion 121 of the armrest body 120 while moving along the guide groove portion 121. The bending portion 133a may be bent from one end of the guide portion 133 to extend, and may be inserted into the guide groove portion 121 to prevent the armrest cover 130 from being separated during use.

In an embodiment, a protrusion portion 134 may be provided on an inner circumferential surface of the armrest cover 130 so that the position of the armrest cover 130 may be fixed at a predetermined position of the armrest body 120. In addition, a fixing groove portion 122 may be provided in an outer circumferential surface of the armrest body 120 so that the protrusion portion 134 may be inserted thereinto. That is, the armrest cover 130 may move forward and backward in a longitudinal direction of the armrest body 120, and the protrusion portion 134 provided on the inner circumferential surface of the armrest cover 130 may be inserted into the fixing groove portion 122 of the outer circumferential surface of the armrest body 120, and thus, the armrest cover 130 may be stably fixed at the predetermined position.

In a specific embodiment, the protrusion portion 134 may be provided as a clip spring portion 134 on the armrest cover 130. The clip spring portion 134 may be inserted into the fixing groove portion 122 to fix the armrest cover 130 at the predetermined position. When a user intentionally pulls or pushes the armrest cover 130, because the clip spring portion 134 may be elastically deformed and escape from the fixing groove portion 122, the clip spring portion 134 may be moved back to another position. A pair of fixing groove portions 122 may be respectively formed in opposite sides of the armrest body 120. The fixing groove portions 122 may include a first fixing groove portion 122a for fixing a position where the armrest cover 130 entirely covers the armrest body 120 as shown in FIG. 1 and a second fixing groove portion 122b for fixing a position where the armrest body 120 has moved forward as shown in FIG. 12.

The clip spring portion 134 may be seated in the first fixing groove portion 122a at the position where the armrest cover 130 entirely covers the armrest body 120, and when the clip spring portion 134 is seated in the second fixing groove portion 122b while slidably moving forward, the clip spring portion 134 may be fixed at a corresponding position.

The armrest cover 130 may be slidably movable even at the second position where the armrest body 120 moves upward as shown in FIG. 13.

As described above, the armrest body 120 and the armrest cover 130 may be slidably movable, and the armrest cover 130 may be prevented from being arbitrarily moved or separated in a situation not intended by the user during use.

In the armrest of the disclosure and the console assembly including the armrest, the height of the armrest may be adjusted through the link unit, and thus, the user’s arms may be rested on the armrest more comfortably depending on the user's physical condition or posture, and the armrest may be moved up and down by unlocking the position of the armrest with a simple operation of pressing the switch.

In addition, by allowing the armrest upper cover to slidably move in the longitudinal direction, the position of the armrest where the user’s arms are rested may be adjusted.

The armrest of the disclosure and the console assembly including the armrest may significantly improve user convenience through a height adjustment function of the armrest compared to the existing stationary armrest.

In addition, the armrest may be applied to various body conditions of the user through a movement function of the armrest cover.

The effects of the disclosure are not limited to the above-mentioned effects, and other effects not mentioned will be clearly understood by one of ordinary skill in the art from the description provided above.

Although the disclosure has been described with reference to the embodiment shown in the drawings, this is merely exemplary and will be understood by one of ordinary skill in the art that various modifications and equivalent other embodiments are possible. Therefore, the true technical protection scope of the disclosure will be defined by the technical sprit of the appended claims.

What is claimed is:

1. An armrest provided on a moving object, the armrest comprising:
a base frame;
an armrest body that is movable up and down with respect to the base frame;
an armrest cover mounted on an upper portion of the armrest body; and
a link unit allowing the armrest body to move up and down with respect to the base frame,
wherein a height of the armrest body is adjusted to a first position at which the armrest body is seated on the base frame and a second position at which the armrest body moves upward to the highest position, according to an operation of the link unit.

2. The armrest of claim 1, wherein the link unit includes a first link and a second link connecting the base frame to the armrest body and intersecting each other, and the height of the armrest body is adjusted as an intersection angle of the first link and the second link changes.

3. The armrest of claim 2, wherein the link unit includes a torsion spring provided on one of the first link and the second link to bias the armrest body upward.

4. The armrest of claim 2, wherein ends of the first link and the second link are rotatably connected to the base frame and the armrest body, respectively, and other ends of the first link and the second link are guided and connected to a link connection groove of the base frame and a link connection groove of the armrest body to be rotatable and horizontally movable.

5. The armrest of claim 4, further comprising a locking unit locking an operation of the link unit such that the armrest body is fixed at the first position and the second position.

6. The armrest of claim 5, wherein the locking unit comprises:
a rotatable stopper restricting a movement of the other end of the second link moving within the link connection groove of the base frame; and
a switch unit rotating the stopper.

7. The armrest of claim 6, wherein two groove portions in which a rotation axis of the other end of the second link is seated are provided in the stopper.

8. The armrest of claim 7, wherein the switch unit comprises:
a switch provided to be exposed to the base frame; and
a stopper link connecting one end of the switch to one end of the stopper so as to rotate the stopper according to up-and-down movement of the switch.

9. The armrest of claim 8, wherein one end of the stopper link is connected to the switch, and
a cam rotating according to a movement of the stopper link and engaged with a gear of the stopper is provided in the other end of the stopper link.

10. The armrest of claim 1, wherein the armrest cover is movable in a longitudinal direction from the armrest body.

11. The armrest of claim 10, wherein a protrusion portion is provided on an inner circumferential surface of the armrest cover such that the armrest cover is fixed at a predetermined position of the armrest body, and
a fixing groove portion into which the protrusion portion is inserted is provided in an outer circumferential surface of the armrest body.

12. A console assembly provided on a moving object, the console assembly comprising:
a console body provided on the moving object and storing items; and
an armrest with one end rotatably provided on an upper portion of the console body,
wherein the armrest comprises:
a base frame;
an armrest body that is movable up and down with respect to the base frame;
an armrest cover mounted on an upper portion of the armrest body; and
a link unit allowing the armrest body to move up and down with respect to the base frame, and
a height of the armrest body is adjusted to a first position at which the armrest body is seated on the base frame and a second position at which the armrest body moves upward to the highest position, according to an operation of the link unit.
